(19) United States
(12) Patent Application Publication
(10) Pub. No.: US 2026/0230984 A1
(43) Pub. Date: Aug. 6, 2026

(54) System and Method for Managing Communications Based on Network Coverage

(71) Applicant: Zebra Technologies Corporation, Lincolnshire, IL (US)

(72) Inventors: Gina Otts, Prairie du Chien, WI (US); Durgendra Narayan Singh, Twin Falls, ID (US); Thomas Puchala, Dallas, TX (US)

(73) Assignee: Zebra Technologies Corporation, Lincolnshire, IL (US)

(21) Appl. No.: 19/223,999

(22) Filed: May 30, 2025

Related U.S. Application Data
(60) Provisional application No. 63/755,179, filed on Feb. 6, 2025.

(51) Int. Cl. H04W 36/32; H04W 16/18

(52) U.S. Cl. CPC H04W 36/322; H04W 16/18

(57) ABSTRACT

An example method includes: detecting, at a device, a switch of communications coverage from a primary network to a secondary network; determining a coverage interval to return to communications coverage by the primary network; detecting, during the communications coverage by the secondary network, a communications request; determining a classification of the communications request; and processing the communications request based on the classification and the coverage interval.

### CROSS-REFERENCE TO RELATED APPLICATIONS

This application claims priority to U.S. application No. 63/755,179 filed Feb. 6, 2025 entitled “System and Method for Application Optimization over Constrained Satellite Links”, the contents of which are incorporated herein by reference in its entirety.

### BACKGROUND

Mobile devices may be configured to communicate via multiple different protocols, such as WiFi, cellular, and satellite communications. Some networks, such as WiFi and cellular, may be fast and inexpensive, but may have limited range. Other networks, such as satellite, may be slow and expensive, but may have more extensive range.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of an example system for managing communications based on network coverage.

FIG. 2 is a block diagram of certain internal hardware components of the mobile device of FIG. 1.

FIG. 3 is a flowchart of an example method for managing communications based on network coverage.

FIG. 4 is a schematic diagram of the device of FIG. 1 operating in a secondary communications mode.

FIG. 5 is a flowchart of an example method of processing communications requests in the method of FIG. 3.

FIG. 6 is a schematic diagram of an example performance of the method of FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: detecting, at a device, a switch of communications coverage from a primary network to a secondary network; determining a coverage interval to return to communications coverage by the primary network; detecting, during the communications coverage by the secondary network, a communications request; determining a classification of the communications request; and processing the communications request based on the classification and the coverage interval.

Additional examples disclosed herein are directed to a device comprising: a communications interface configured to communicate over a primary network and a secondary network; and a processor interconnected with the communications interface, the processor configured to: detect a switch of communications coverage from the primary network to the secondary network; determine a coverage interval to return to communications coverage by the primary network; detect, during the communications coverage by the secondary network, a communications request; determine a classification of the communications request; and process the communications request based on the classification and the coverage interval.

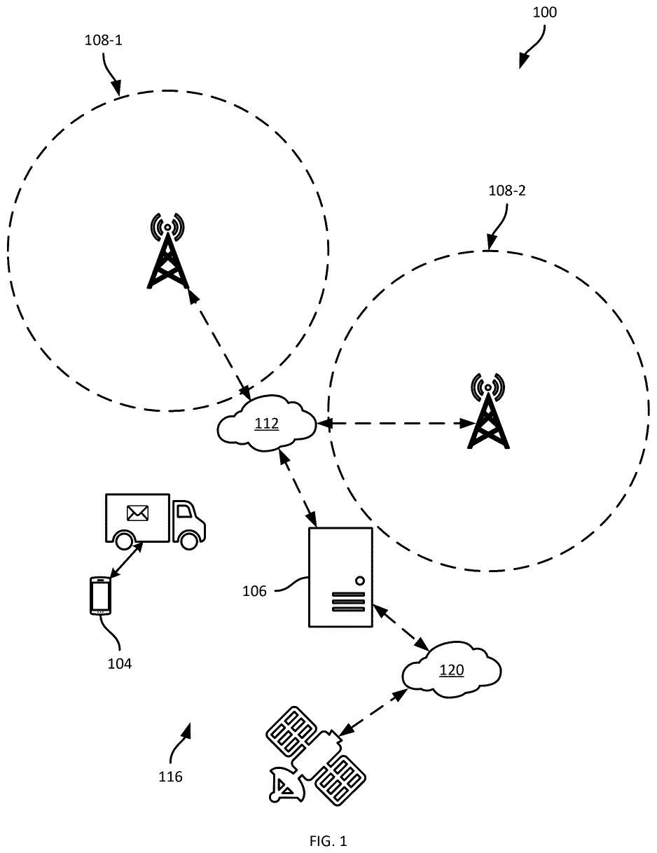

FIG. 1 depicts a system 100 including a mobile device 104 configured to manage communications based on network coverage in accordance with the teachings of this disclosure. The system 100 may be deployed for various services including, but not limited to, a mail and/or package delivery service, in which individual users and/or devices are equipped with devices 104 which may traverse geographical regions, including both urban and rural regions. The device 104 may be configured to communicate with a server 106, for example configured to manage the logistics of the delivery service. Different geographic regions may have differing robustness of network coverage by different networks, including cellular networks, satellite networks, radio networks, WiFi networks and the like. Accordingly, the mobile device 104 is configured to manage communications according to network coverage.

The mobile device 104 may be a cell phone, tablet, wearable device, portable computing device, or the like. The device 104 may be configured to communicate via multiple wide area communications protocols, including, but not limited to WiFi, cellular communications, radio communications, satellite communications, and the like.

The device 104 may move between different zones of network coverage, such as between primary coverage zones 108-1 and 108-2 (referred to generically as a coverage zone 108 and collectively as the coverage zones 108; this nomenclature may also be used elsewhere herein) supported by a primary network 112 and a secondary coverage zone 116 supported by a secondary network 120. For example, the primary network 112 may be a cellular or WiFi network or other low-cost network, but may have incomplete or limited coverage, for example in rural or remote regions, based on the available infrastructure to support the primary network 112. The secondary network 120 may have more complete coverage in such rural or remote regions, but may be more expensive, such as a satellite network.

In some examples, communications by the mobile device 104 may be disabled when communications coverage is only provided by the secondary network 120. However, urgent or critical communications may then be delayed until the mobile device 104 returns to communications coverage by the primary network 112, resulting in process delays and the like. If communications are enabled during communications coverage by the secondary network 120, extra costs and computing resources may be expended to enable the communications, including for non-critical communications, such as social media updates, non-time-sensitive updates, and the like.

That is, conventional communications management over secondary networks is lacking and inefficient. Enabling secondary network communication for non-critical communications utilizes extra computing resources, to enable the secondary network communications and utilizes additional bandwidth, resulting in higher costs for such communications. Additionally, secondary network communications may typically be slower, and the transmission of additional non-critical information may consume bandwidth and delay the timely delivery of critical communications between devices. On the other hand, restricting all secondary network communications also causes a delay of timely delivery of critical communications between devices.

Thus, it is an objective of the present disclosure to manage secondary network communications to enable the timely delivery of critical communications between devices while minimizing bandwidth and computational resources utilized by the transmitting device.

Accordingly, as described herein, the mobile device 104 may be configured to efficiently manage communications to optimize communication cost and communication delays. In particular, the mobile device 104 may determine a coverage interval (e.g., a time and/or distance) until the device 104 is expected to return to communications coverage by the primary network. For example, the coverage interval may be determined based on previously created coverage area maps, device properties, such as a global positioning system (GPS) location, inertial measurement unit (IMU) measurements to determine a direction and speed of movement, user analytics to determine if the device 104 is carried by a walking user, a vehicle, downtime (e.g., stops and starts) and/or direction switching, and the like, which may affect the coverage interval.

When device applications generate a communications request, the device 104 may be configured to determine a classification of the communications request as a whole, a classification of certain data fields within the communications request, or similar, and process the communications requests based on the classification and the coverage interval. For example, a predefined set of data field types may be classified for consideration to transmit during communications coverage by the secondary network 120, while another set of data field types may be stored for transmission upon return to communications coverage by the primary network 112. The data fields which are classified for consideration may further be assigned a priority classification, with certain priority classifications being transmitted over the secondary network 120 based on the coverage interval, and certain priority classifications being stored for transmission upon return to communications coverage by the primary network 112 based on the coverage interval.

In particular, the classification of communication requests by type and priority allows a subset of communications, namely the critical or time-sensitive communications, to be transmitted in a timely fashion, particularly in consideration of selectively transmitting data based on the determined coverage interval. Further, the classification of data fields within each communication request conserves bandwidth and computational resources by selectively communicating portions of the communications. That is, the present disclosure describes improvements in computer functionality or improvements to other technologies at least because the present disclosure describes that devices with primary and secondary communications capabilities may be improved or enhanced with the classification and selective transmission of data. This improves the functioning of a communication device itself because computational resources and bandwidth to transmit data over a secondary network is optimized to be more efficient using the described classifications and consideration of the coverage interval, while enabling efficient and timely delivery of critical data. This improves the state of the art at least because previous communication devices operate in modes which are inefficient with respect to optimizing utilized bandwidth, or non-operative to transmit critical data.

In addition, the present disclosure includes applying various features and functionality, such as the classification of communication requests by type and priority, the further classification of data fields, the determination of the coverage interval, and other functionality as described herein, with, or by use of, a particular machine, e.g., a mobile device, another communication device, and/or other hardware components as described herein.

Moreover, the present disclosure includes specific features other than what is well-understood, routine, conventional activity in the field, or adding unconventional steps that demonstrate, in various embodiments, particular useful applications. For example, the device applies prescribed threshold times according to the classifications to selectively transmit the communication requests and/or the data fields in consideration of the determined coverage interval to optimize timely delivery of data in the secondary coverage zone in addition to the computational expense and bandwidth of secondary network communications.

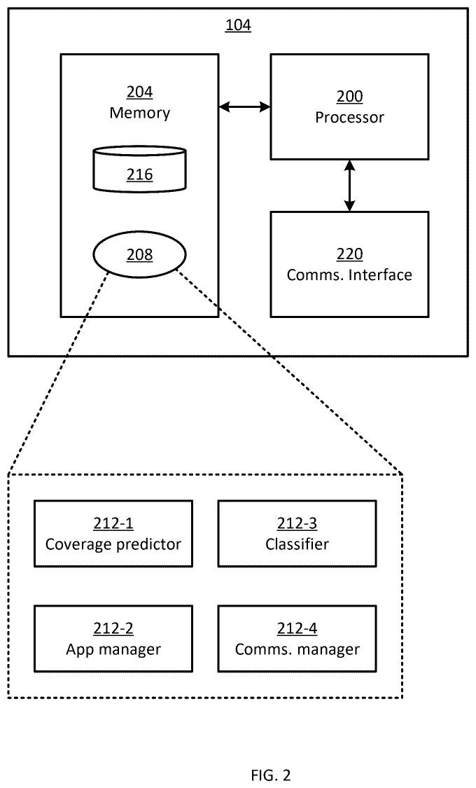

Turning now to FIG. 2, certain internal components of the mobile device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits.

The memory 204 stores computer-readable instructions for execution by the processor 200. In particular, the memory 204 stores an application 208 which, when executed by the processor 200, configures the processor 200 to perform various functions discussed below in greater detail and related to the communications management operation of the device 104. The application 208 may include a plurality of functional sub-modules 212 which may also be implemented as a suite of distinct applications.

In particular, the application 208 includes a coverage predictor 212-1 configured to determine the coverage interval. The coverage predictor 212-1 may determine the coverage interval based on a density-clustering-based map of network coverage regions or zones for the primary network. The coverage predictor 212-1 may additionally obtain device and user parameters, such as location, direction of movement, speed of movement, historical device movement patterns and the like and apply such parameters to refine the coverage interval determination.

The application 208 further includes an application manager 212-2 configured to manage communication request permissions at an application level. For example, device applications may enroll with the application manager 212-2 to enable communication requests to be processed from the device applications when communications coverage is provided by the secondary network 120. That is, the application manager 212-2 may effectively define a limited workspace, in which a first subset of device applications are enrolled to enable restricted and optimized communications requests as described herein. A second subset of device applications which are not enrolled in the workspace may be disabled by the application manager 212-2.

The application 208 further includes a classifier 212-3 configured to classify the communications request as a whole, classify data fields by type, such as by critical and non-critical fields, classify data fields by priority, and the like. For example, the data classifier 212-3 may include a predefined list of critical field types or field types otherwise flagged for secondary communications consideration. The data field classifier 212-3 may further determine a priority classification of each data field, for example according to predefined priority classification for each field type or based on user input.

The application 208 further includes a secondary communications manager 212-4 configured to process communications requests based on the classification of the communications requests (e.g., including the data field type classification, the priority classification, or other suitable classifications), the determined coverage interval (e.g., as determined by the coverage predictor 212-1), and any other suitable parameters. In particular, the secondary communications manager 212-4 may enable communications requests to be transmitted over the secondary network 120 or stored for transmission upon return to communications coverage by the primary network 112.

Those skilled in the art will appreciate that the functionality implemented by the processor 200 may also be implemented by one or more specially designed hardware and firmware components, such as a field-programmable gate array (FPGAs), application-specific integrated circuits (ASICs) and the like in other embodiments. In an embodiment, the processor 200 may be, respectively, a special purpose processor which may be implemented via dedicated logic circuitry of an ASIC, an FPGA, or the like to enhance the processing speed of the operations discussed herein.

The memory 204 also stores a repository 216 storing rules and data for the communications management operation. For example, the repository 216 may store the list of device applications enrolled with the application manager 212-2, the predefined list of critical-type data fields, the predefined mapping of priority classifications of data fields, and the like.

The device 104 also includes a communications interface 220 enabling the device 104 to exchange data with other computing devices such as the server 106. The communications interface 220 is interconnected with the processor 200 and includes suitable hardware (e.g. transmitters, receivers, network interface controllers and the like) allowing the device 104 to communicate over different networks, in particular, at least the primary network 112 and the secondary network 120. The specific components of the communications interface 220 are selected based on the type of network or other links that the device 104 is to communicate over. The communications interface 220 may further be enabled to allow communications over other types of networks or communication links, including short-range and/or near-field communications, wired communications, combinations of the above, and the like.

The device 104 may further include one or more input and/or output devices (not shown). The input devices may include one or more buttons, keypads, touch-sensitive display screens or the like for receiving input from an operator. The output devices may further include one or more display screens, sound generators, vibrators, or the like for providing output or feedback to an operator.

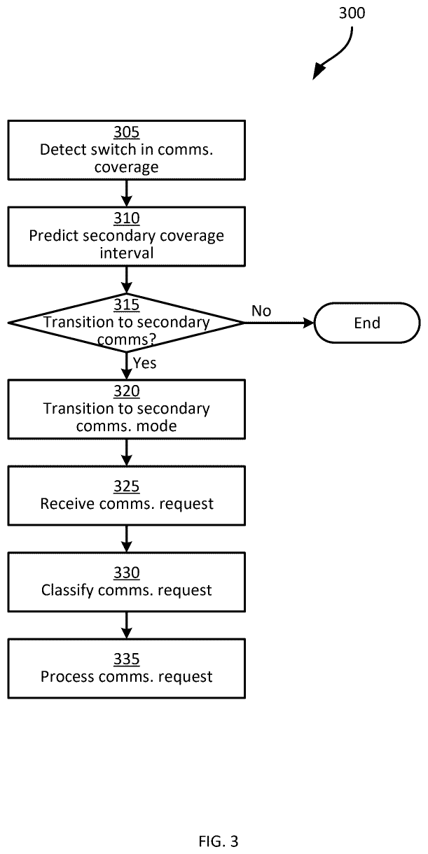

Turning now to FIG. 3, the functionality implemented by the device 104 will be discussed in greater detail. FIG. 3 illustrates a method 300 of managing communications based on network coverage. The method 300 will be discussed in conjunction with its performance in the system 100, and particularly by the device 104, via execution of the application 208. In particular, the method 300 will be described with reference to the components of FIGS. 1 and 2. In other examples, the method 300 may be performed by other suitable devices or systems.

The method 300 is initiated at block 305, where the device 104 detects a switch of communications coverage from the primary network 112 to the secondary network 120. For example, if the primary network 112 is a cellular network, the device 104 may be in regular communication with a base station, hence the device 104 may detect that communications with a base station implementing the cellular network is no longer available. Accordingly, the device 104 may determine that the device 104 has left (e.g., is no longer present within) one of the primary network coverage zones 108 and may therefore determine that the device 104 is located in the secondary network zone 116.

At block 310 the device 104 may determine the coverage interval. In particular, the coverage interval may represent a determined “time-to-service”, or interval in which the device 104 is expected to be in communications coverage by the secondary network 120 until a return to communications coverage or “service” by the primary network 112. In some examples, the coverage interval may additionally include and/or represent a distance and/or range estimate that the device 104 is located from a primary coverage zone 108.

In particular, to obtain the determined coverage interval, the device 104 may obtain a coverage map for the primary network 112. The coverage map for the primary network 112 may be maintained by the server 106 and/or another suitable centralized management device for the primary network 112, based on data points generated by mobile devices, such as the device 104, capturing the location and most recent received signal strength indicator (RSSI) of primary network 112 coverage at a point in time at which the devices toggle from primary network coverage to secondary network coverage. The server 106 may then apply a density-based clustering algorithm to the data points to generate the coverage map. Since the device 104 may apply the coverage map for the primary network 112 when the device 104 is outside of one of the primary coverage zones 108, the device 104 may periodically (e.g., once per day, once per week, etc.) obtain a current version of the coverage map from the server 106 (e.g., while the device 104 is within one of the primary coverage zones 108) and store a local copy of the coverage map at the device 104. Accordingly, at block 310, the device 104 may retrieve a copy of the coverage map from the memory 204.

Based on the current location of the device 104 and the coverage map, the device 104 may determine a distance from the device 104 to a primary coverage zone 108. Depending on the route taken by the device 104, the distance from the device 104 to a nearest primary coverage zone 108 may not directly correlate to the time until the device 104 returns to a primary coverage zone 108. Accordingly, the device 104 may further obtain device and/or user parameters to refine the determined coverage interval.

For example, the device and/or user parameters may include a direction and speed of movement of the device 104, for example as obtained from the IMU of the device 104, a GPS location of the device 104, and the like. Thus, if the device 104 is moving in a direction opposite to the nearest primary coverage zone 108, then the device 104 may adjust the determined coverage interval based on the nearest primary coverage zone 108 in the direction of travel of the device 104 (e.g., within a threshold tolerance or buffer zone) and based on the speed of travel of the device 104.

The device and/or user parameters may further include a current route (e.g., as mapped by a GPS navigation program), assigned tasks or locations for the user and/or device (e.g., based on an enterprise-based work assignment or the like), and the like. If a route and/or assigned tasks or locations are provided, then the device 104 may determine the determined coverage interval based on a primary coverage zone 108 overlapping with the route and/or assigned location. Further, the device 104 may adjust the time estimate based on an expected duration of completion of a task (e.g., an expected duration to deliver a package at a given location) or the like.

In some examples, the device and/or user parameters may further include historical data and analytics, including for example, historical movement analytics, such as paths or routes traversed by the user and/or the device 104. For example, the historical data may indicate that the expected duration of task completion for a particular user is shorter or longer than expected. In other examples, the historical data may indicate a pattern of direction switching in a certain region (e.g., to allow route prediction if a GPS-navigation mapped route is not provided), which may affect the coverage interval.

In other examples, other parameters may also be applied by the coverage predictor 212-1 to further increase the accuracy of the determined coverage interval.

At block 315, the device 104 may determine whether to transition to a secondary communications mode for restricted and prioritized communications over the secondary network 120.

In some examples, the determination at block 315 may be performed automatically, based on a device setting. The determination may further be made based on the determined coverage interval. For example, if the coverage interval is determined to be less than a prescribed threshold time (e.g., one minute), then the device 104 may simply wait until communications coverage returns to the primary network 112.

In other examples, the determination at block 315 may be performed based on user input. In such examples, the device 104 may present, at a display of the device 104, a prompt or query for the user to approve a manual transition to the secondary communications mode. In some examples, the device 104 may additionally present the determined coverage interval with the prompt or query to allow the user to consider the time-to-service by the primary network 112 and any associated communication delays if the transition to the secondary communications mode is not made.

If the determination at block 315 is negative, that is, the transition to the secondary communications mode is not pursued, then the method 300 ends. If the determination at block 315 is affirmative, that is, the device 104 transitions to the secondary communications mode, then the device 104 proceeds to block 320. If the determination at block 315 is affirmative, the device 104 may additionally track and store a current location, a most recent RSSI relative to the primary network 112 and other parameters to transmit to the server 106 to add to the coverage map.

At block 320, the device 104 may activate the application manager 212-2 to maintain communications functionality for a first subset of device applications and disable communications functionality for a second subset of device applications. For example, the first subset of device applications may include a predefined list of emergency and base device services, as well as device applications enrolled with the application manager 212-2. For example, in a mail-delivery enterprise deployment, the first subset of device applications may include applications for managing package delivery assignments and locations, payment provisioning applications, and the like. The second subset of device applications may include background services and other device applications such as social and/or messaging applications and other non-enterprise related applications. In some examples, disabling the second subset of device applications may include disabling or ignoring communications requests initiated by the device applications in the second subset.

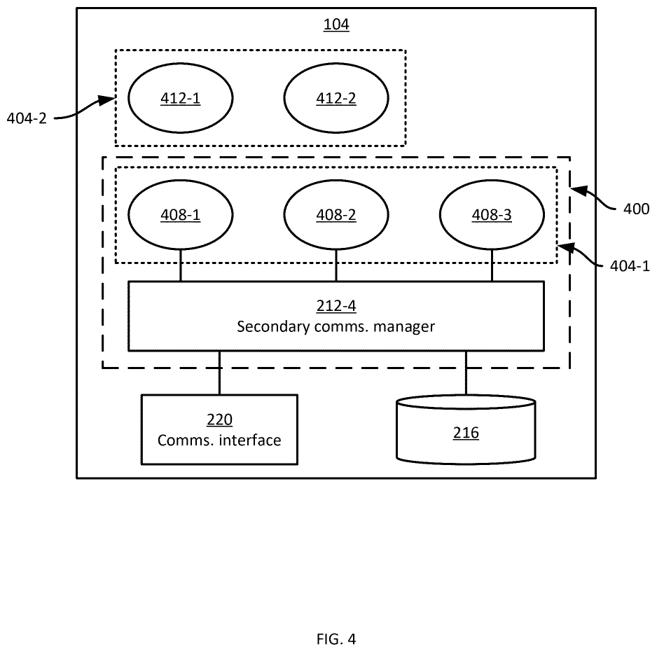

For example, referring to FIG. 4, an example schematic diagram of the operation of the device 104 in the secondary communications mode is depicted.

To manage the secondary communications mode, the application manager 212-2 may initialize a virtual workspace 400 for communications over the secondary network 120. In particular, the secondary communications manager 212-4 may operate within the virtual workspace 400 and cooperate with the communications interface 220 to enable device communications over the secondary network 120. The device 104 includes a first subset 404-1 of first device applications 408-1, 408-2, and 408-3 which are enrolled in the virtual workspace 400 and may therefore be configured to operate in the virtual workspace 400. The device 104 further includes a second subset 404-2 of second device applications 412-1, and 412-2 which are not enrolled in the virtual workspace 400 and therefore operate outside the virtual workspace 400. In other examples, more or fewer first device applications 408 and second device applications 412 are also contemplated.

In operation, communications requests from first device applications 408 in the virtual workspace 400 may access the secondary communications manager 212-4 and therefore such communications requests may be processed to be transmitted over the secondary network 120 or stored for transmission upon return to communications coverage by the primary network 112. Communication requests from second device applications 412 outside the virtual workspace 400 may not access the secondary communications manager 212-4 and hence communications requests from the second subset of device applications while in the secondary coverage zone 116 may be disabled by the virtual workspace 400.

Returning to FIG. 3, at block 325, the device 104, and in particular, the secondary communications manager 212-4 may receive a communications request from one of the device applications. More particularly, the communications request may be received from one of the device applications in the first subset.

At block 330, the device 104, and in particular, the classifier 212-3 is configured to classify the communications request. The classifier 212-3 may be configured to classify the communications request as a whole. For example, certain workflow processes and corresponding communications requests executable by each device application may be classified as critical, time-sensitive, important or otherwise flagged for secondary communications consideration, while other workflow processes and corresponding communications requests may be non-critical.

The communications request may further include a plurality of data fields within the request. For example, a communications request to process a successful delivery of a package may include data fields for the date and time of delivery, a success indicator, an image field for proof-of-delivery, and optional notes. Accordingly, the classifier 212-3 may further be configured to classify individual data fields by type as being flagged for secondary communications consideration, or as being non-critical. For example, the date and time of delivery, the success indicator, and the image may be classified for secondary communications consideration, while the notes may be classified as non-critical.

Within the data fields classified for secondary communications consideration, the classifier 212-3 may further determine a priority classification of the data fields. The priority classifications may be associated with prescribed threshold times to be used in comparison with the determined coverage interval during processing of the communications request. In some examples, the threshold time may be predefined based on the field type, while in other examples, the threshold time may be predefined based on the priority classification. Thus, for example, the priority classifications may include a high priority classification with no associated threshold time (i.e., the data field is to be sent via secondary communications), a medium priority classification with a threshold time of, for example 20 minutes, and a best effort priority classification with a threshold time of, for example, one hour.

At block 335, the device 104, and in particular, the secondary communications manager 212-4 is configured to process the communications request based on the coverage interval determined at block 310 and the classification determined at block 330. For example, the secondary communications manager 212-4 may transmit the communications request over the secondary network 120, or the secondary communications manager 212-4 may store the communications request to be transmitted upon return to communications coverage by the primary network 112. The device 104 may periodically check for a subsequent switch of communications coverage from the secondary network 120 to the primary network 112, and upon detecting communications coverage by the primary network 112, the device 104 may transmit the communications requests stored in the repository 216.

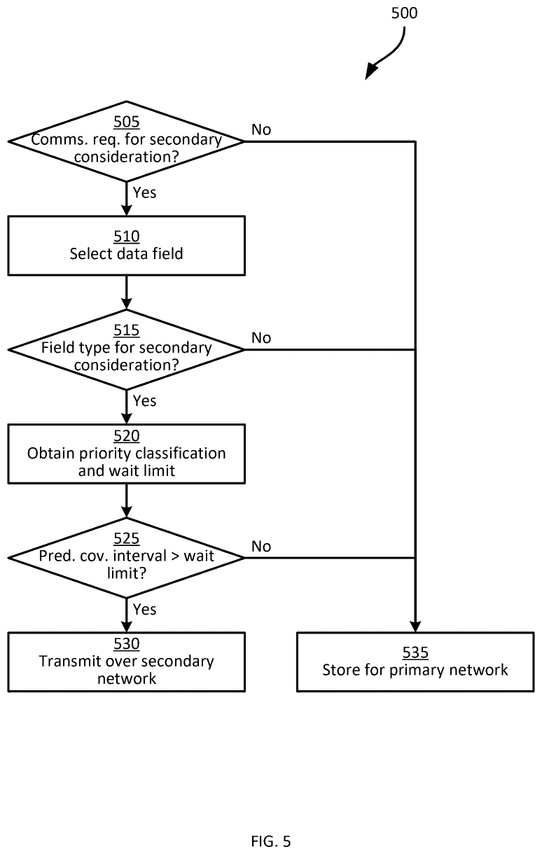

For example, referring to FIG. 5, an example method 500 of processing the communications request is depicted. For example, the method 500 may be performed by the secondary communications manager 212-4.

At block 505, the secondary communications manager 212-4 determines whether the communications request as a whole is flagged for secondary communications consideration. In particular, the secondary communications manager 212-4 may reference the classification performed by the classifier 212-3 at block 330 of the method 300. For example, a time and/or location tracking process to track working time and location of a delivery vehicle and/or device may be provided as part of a delivery management application, however the time and location tracking process may be deemed non-critical. In contrast, a delivery tracking process may be flagged for secondary communications consideration.

If the determination at block 505 is negative, that is, the communications request is deemed non-critical, then the secondary communications manager 212-4 proceeds to block 535 to store the communications request (e.g., in the repository 216) and the associated data fields for transmission upon return to communications coverage by the primary network 112.

If the determination at block 505 is affirmative, then the secondary communications manager 212-4 proceeds to block 510. Within the communications request, certain data fields may be classified as critical and/or otherwise flagged for secondary communications consideration, while other data fields may be classified as non-critical. Accordingly, at block 510, the secondary communications manager 212-4 is configured to select one of the data fields in the communications request to analyze with respect to the secondary communications.

At block 515, the secondary communications manager 212-4 is configured to determine whether the selected data field is classified for secondary communications consideration. In particular, the secondary communications manager 212-4 may reference the classification performed by the classifier 212-3 at block 330 of the method 300. For example, in the delivery tracking process, the data fields relating to the date and time of delivery, the success indicator, and the image including proof of delivery may be classified for secondary communications consideration, while the notes may be classified as non-critical.

If the determination at block 515 is negative, that is, the field type classification is non-critical, then the secondary communications manager 212-4 proceeds to block 535 to store the non-critical data field for transmission upon return to communications coverage by the primary network 112.

If the determination at block 515 is affirmative, then the secondary communications manager 212-4 proceeds to block 520. At block 520, the secondary communications manager 212-4 is configured to obtain the priority classification and threshold time for the priority classification for the data field. In particular, different data fields flagged for secondary communications coverage may have different priority classifications and different thresholds for transmitting the data field via secondary communications.

For example, emergency and/or SOS alerts may be transmitted in real time. Similarly, payment processing and the success indicator of the delivery tracking process may be used elsewhere by the server-side delivery tracking algorithm, and accordingly, may be flagged for transmission in real time. Other data fields, such as the date and time of delivery and the image containing proof-of-delivery may have certain delays. For example, the datetime of the success indicator may be used as a proxy for the recorded date and time of delivery, and hence the recorded date and time of delivery may have a threshold time of twenty minutes. The image containing proof-of-delivery may be larger in size, and hence the threshold time may be higher and may be designated to be one hour.

In particular, the threshold time is indicative of a threshold time by which the data field should be delivered to the target device (e.g., the server 106). Thus, for coverage intervals within the threshold time, the device 104 may be configured to wait until communications coverage by the primary network 112 to transmit the data field, while transmitting the data fields over the secondary network for data fields in which the coverage interval exceeds the threshold time.

Thus, at block 525, the secondary communications manager 212-4 is configured to determine whether the determined coverage interval exceeds the threshold time for the data field.

If the determination at block 525 is negative, that is, the threshold time is greater than the predicted coverage interval, then the secondary communications manager 212-4 proceeds to block 535 to store the data field for transmission upon return to communications coverage by the primary network 112. That is, the device 104 is expected to return to communications coverage by the primary network 112 within the threshold time, and hence storing the data field for transmission by the primary network 112 will not result in a delay exceeding the threshold time for the data field.

If the determination at block 525 is affirmative, that is, the determined coverage interval exceeds the threshold time, then the secondary communications manager 212-4 proceeds to block 530 to transmit the data field over the secondary network 120. That is, the device 104 is expected to return to communications coverage by the primary network 112 after the threshold time has been exceeded. Accordingly, the device 104 determines that to deliver or transmit the data within the prescribed threshold time, the data field is to be delivered using the secondary communications protocol over the secondary network 120.

Thus, at block 530, the data field is transmitted over the secondary network 120. In some examples, the communications manager 212-4 may iterate through blocks 510 through 535 for each data field in the communications request and accumulate the data fields for transmission over the secondary network 120 prior to the transmission at block 530. That is, the transmission at block 530 may include all the data fields from the communications request which are identified for secondary communications transmission.

At block 535, the communications requests, non-critical data field types, and data fields with sufficiently low priority classifications to be delayed based on the coverage interval are stored, for example in the repository 216 for transmission upon return to communications coverage by the primary network 112.

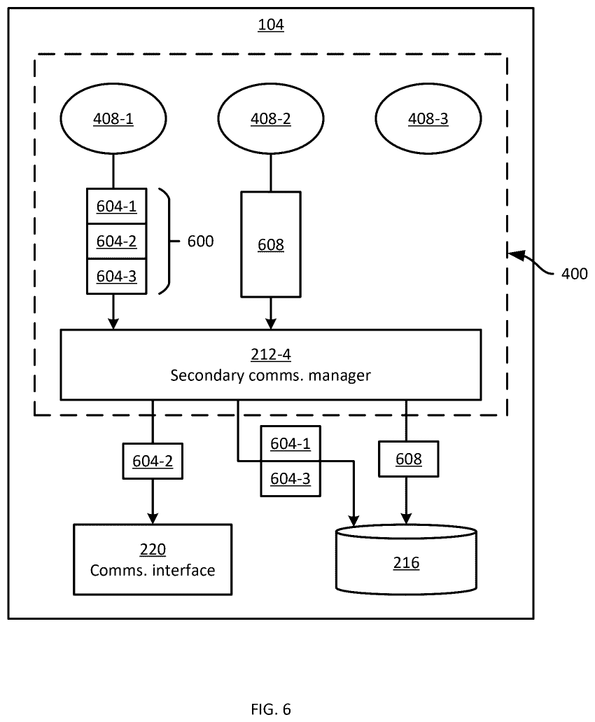

For example, referring to FIG. 6, a schematic diagram of an example performance of the method 500 is depicted.

In particular, one of the first device applications 408-1, which may be a delivery tracking application, may generate a communications request 600 and send it to the secondary communications manager 212-4. In particular, the communications request 600 may include data fields 604-1, 604-2, and 604-3. For example, the communications request 600 may be the delivery notification as described above and may include the date and time of delivery as the data field 604-1, the success indicator as the data field 604-2, and the image of proof-of-delivery as data field 604-3. The secondary communications manager 212-4 may determine that the success indicator data field 604-2 is to be transmitted over the secondary network 120, and hence may pass the success indicator data field 604-2 to the communications interface 220 for transmission. The secondary communications manager 212-4 may pass the delivery data field 604-1 and the image of proof-of-delivery data field 604-2 to the repository 216 for storage.

In another iteration, another one of the first device applications 408-2 may generate a different communications request 608. The secondary communications manager 212-4 may determine that the type of the communications request 608 as a whole is non-critical (i.e., according to the classification given by the classifier 212-3) and hence may pass the communications request 608 (and associated data fields within the communications request 608) to the repository 216 for storage.

Upon detecting the return to communications coverage by the primary network 112, the device 104 may transmit, via the communications interface 220, the data fields 604-1 and 604-3 and the communications request 608 over the primary network 112.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
detecting, at a device, a switch of communications coverage from a primary network to a secondary network;
determining a coverage interval to return to communications coverage by the primary network;
detecting, during the communications coverage by the secondary network, a communications request;
determining a classification of the communications request; and
processing the communications request based on the classification and the coverage interval.

2. The method of claim 1, wherein processing the communications request comprises at least one of:
transmitting the communication request over the secondary network; and
storing the communications request to be transmitted upon return to communications coverage by the primary network.

3. The method of claim 1, further comprising, transitioning to a secondary communications mode by:
allowing communications requests from a first subset of device applications; and
disabling a second subset of device applications.

4. The method of claim 3, wherein transitioning to the secondary communications mode comprises:
automatically transitioning to the secondary communications mode in response to detecting the switch of communications coverage to the secondary network; or
presenting the coverage interval to prompt a manual transition to the secondary communications mode based on the coverage interval.

5. The method of claim 1, wherein determining the classification of the communications request comprises:
storing a first subset of data fields of the communications request to be transmitted upon return to communications coverage by the primary network; and
processing a second subset of data fields for transmission over the secondary network.

6. The method of claim 5, wherein processing the second subset of data fields comprises, for each data field in the second subset:
obtaining a priority classification for the data field; and
transmitting the data field over the secondary network according to the priority classification.

7. The method of claim 6, further comprising, for each data field in the second subset:
obtaining a threshold time for the priority classification of the data field;
transmitting the data field over the secondary network if the coverage interval is greater than the threshold time; and
storing the data field to be transmitted upon return to communications coverage by the primary network if the coverage interval is less than the threshold time.

8. The method of claim 1, wherein determining the coverage interval comprises:
obtaining a coverage map of communications coverage by the primary network;
obtaining a set of device and user parameters; and
applying the set of device and user parameters and the coverage map to estimate the coverage interval.

9. The method of claim 8, wherein the device and user parameters comprises one or more of:
a current location of the device;
a direction and speed of movement of the device;
a current route of the device;
a set of tasks assigned to the device; and
historical movement analytics for the device.

10. The method of claim 1, wherein the primary network comprises a cellular network and the secondary network comprises a satellite network.

11. A device comprising:
a communications interface configured to communicate over a primary network and a secondary network; and
a processor interconnected with the communications interface, the processor configured to:
detect a switch of communications coverage from the primary network to the secondary network;
determine a coverage interval to return to communications coverage by the primary network;
detect, during the communications coverage by the secondary network, a communications request;
determine a classification of the communications request; and
process the communications request based on the classification and the coverage interval.

12. The mobile device of claim 11, wherein to process the communications request, the processor is configured to:
transmit the communication request over the secondary network; or
store the communications request to be transmitted upon return to communications coverage by the primary network.

13. The mobile device of claim 11, wherein the processor is further configured to transition to a secondary communications mode by:
allowing communications requests from a first subset of device applications; and
disabling a second subset of device applications.

14. The mobile device of claim 13, wherein to transition to the secondary communications mode, the processor is configured to:
automatically transition to the secondary communications mode in response to detecting the switch of communications coverage to the secondary network; or
present the coverage interval to prompt a manual transition to the secondary communications mode based on the coverage interval.

15. The mobile device of claim 11, wherein to determine the classification of the communications request, the processor is configured to:
store a first subset of data fields of the communications request to be transmitted upon return to communications coverage by the primary network; and
process a second subset of data fields for transmission over the secondary network.

16. The mobile device of claim 15, wherein to process the second subset of data fields the processor is configured to, for each data field in the second subset:
obtain a priority classification for the data field; and
transmit the data field over the secondary network according to the priority classification.

17. The mobile device of claim 16, wherein the processor is further configured to, for each data field in the second subset:
obtain a threshold time for the priority classification of the data field;
transmit the data field over the secondary network if the coverage interval is greater than the threshold time; and
store the data field to be transmitted upon return to communications coverage by the primary network if the coverage interval is less than the threshold time.

18. The mobile device of claim 11, wherein to determine the coverage interval the processor is configured to:
obtain a coverage map of communications coverage by the primary network;
obtain a set of device and user parameters; and
apply the set of device and user parameters and the coverage map to estimate the coverage interval.

19. The mobile device of claim 18, wherein the device and user parameters comprise one or more of:
a current location of the device;
a direction and speed of movement of the device;
a current route of the device;
a set of tasks assigned to the device; and
historical movement analytics for the device.

20. The mobile device of claim 11, wherein the primary network comprises a cellular network and the secondary network comprises a satellite network.
